(19) United States
(12) Patent Application Publication
(10) Pub. No.: US 2005/0001421 A1
(43) Pub. Date: Jan. 6, 2005

(54) Method of customizing bank checks

(76) Inventors: Brad A. Luth, Larkspur, CO (US); Sarah L. Schaefer, Colorado Springs, CO (US)

Correspondence Address: SHERIDAN ROSS PC, 1560 BROADWAY, SUITE 1200, DENVER, CO, 80202, US

(21) Appl. No.: 10/613,893

(22) Filed: Jul. 2, 2003

(51) Int. Cl. B42D 15/00

(52) U.S. Cl. 283/57

(57) ABSTRACT

The present invention is related generally to the method of customizing personal checks. More specifically, a method is provided herein to alter a personal check in such a way as to add selective artistic customization. Preferably, the enhancements are done with an ink stamp and colored pencils, or with adhesive stickers, wherein the user will be able to selectively alter the check. It is envisioned that the images will convey a mood, an emotion, a feeling, or represent an occasion, a cause, or a holiday.

### FIELD OF THE INVENTION

The present invention generally relates to a method of selectively customizing commercial paper to indicate the acknowledgment of a special event, feeling, or cause. More specifically, one embodiment of the present invention provides a method of selectively altering a portion of a personal check with a stamp or sticker to indicate an event, such as a birthday or a holiday.

### BACKGROUND OF THE INVENTION

Personal checks are processed though virtually all financial institutions as a form of legal tender. Generally, when a user writes a check and it is cashed, funds in the amount specified are withdrawn from the user's account. Alternatively, a consumer may answer debts, for example, with currency, wherein the amount owed would be sent to the creditor. This type of transfer however is prone to theft or mistake, wherein all or portion of the amount may be lost or stolen. In addition, personal checks have the advantage of being more secure in that they are provided with a plurality of security features, such as account numbers, name and address of the user, and routing number.

It is advantageous to indicate the nature of a transaction on a personal check in order to maintain proper records. Commonly, personal checks are provided that employ a memorandum line, wherein one may denote the nature of the transaction. Often, however, the check writer forgets to make such an indication, or simply avoids doing so to save time. Alternatively, a graphic depiction of a transaction may be incorporated on a personal check to indicate the nature of the transaction. For example, United State Design Pat. No. 425,934 to Kunkler describes a personal check that employs a plurality of images that depict various activities, wherein the check writer would indicate the nature of the transaction by marking the appropriate image. This type of personal check has the problem of being too cluttered. In addition, the inclusion of many images to a check drastically reduces the amount of space available to provide the required documentation the transaction requires, such as party to be payed and amount paid.

Some personal checks are provided with artistic images thereon. These images are generally constant throughout a book of checks. Alternatively, a book of checks may employ a series of different, but related, preprinted images. These checks are often more expensive than their generic counterparts.

Personal computers are also often employed to create checks. Generally, the user is provided a means to selectively alter a check shown on a computer screen then use the printout as legal tender. More specifically, the user may type in the party to be paid, the amount to be paid, and/or vary various artistic aspects of the check, such as a border. These checks are generally labor intensive to create and require some degree of computer skills to fabricate. In addition, the quality of the finished product depends on the user's printer, and thus checks of this type may be looked at suspect, perhaps counterfeit, by merchants or creditors, and not accepted.

Thus it is a long felt need in the field of commercial paper customization to provide a method to selectively alter a personal check to indicate an event, feeling, or cause, which does not substantially alter the check, is easy to perform, and maintains the document's viability to be used in everyday transactions. The following disclosure describes a method of customizing a portion of a personal check by affixing an image in a predetermined location thereon, thus indicating an event, a feeling, or a cause, such as a birthday, a holiday, a feeling of happiness, breast cancer awareness, etc.

### SUMMARY OF THE INVENTION

It is one aspect of the present invention to provide commercial paper that be adapted to receive an image. More specifically, one embodiment of the present invention is a personal check that includes an area adapted to accommodate an artistic image in conjunction with required items, such as a signatory's address, an amount to be transferred, an account number, a routing number, a date location, a signature line, and a check number.

It is another aspect of the present invention to provide a plurality of stamps that embody various images, wherein the image is transferred to a predetermined location on the check by introducing ink to the stamp and then pressing the inked image onto the predetermined location. Preferably, in one embodiment of the present invention, the stamp is substantially constructed of rubber, but any comparable material known in the art may be used, such as plastic, neoprene, wood, etc. In addition, the present invention uses various depictions, such as the statute of liberty, a boy with an American flag, a girl with an American flag, a heart shape employing the stars and stripes, a star, a “USA” symbol, a girl with baton, an Uncle Sam, a fireworks explosion, a girl with sparklers, an American flag, a boy on a bike with an American flag, a baby, a graduate, newlyweds kissing, a child with birthday cake, candles, a present, an infant, a girl wearing a party hat, a balloon, “it's a boy” message, “it's a girl” message, a Christmas tree, a bride, a ghost, a baseball player, a photograph, a sun, a heart, a reindeer, a dove, a cross, an ark, a shepherd, a bible, a religious symbol, etc.

Alternatively, images that depict a feeling, such as happiness, sadness, pride, joy, concern, surprise, etc., may be employed. Further, images that denote a cause, such as September 11^{th} remembrance, AIDS awareness, cancer awareness, etc., may be employed. Depictions or logos used by organizations or in sports may also be employed to achieve the purpose of the present invention, such as logos or symbols used by the boy scouts, the girl scouts, the American Bar Association, the American Bankers Association, the American Medical Association, the Vietnam Veterans Association, the Army, the Navy, the Air Force, the Coast Guard, the Marines, the National Collegiate Athletic Association, the National Football League, the National Association of Stock Car Auto Racing, the National Basketball Association, Major League Baseball, Major League Soccer, the National Hockey League, the Olympics, etc. Although, the forgoing lists various images that may be employed in one embodiment of the present invention, one skilled in the art will appreciate that any number of depictions or logos may be used to indicate an event, feeling, or cause, such as Halloween, Christmas, a Wedding, an Anniversary, a birthday, Easter, a graduation, Independence day, the feeling of happiness, breast cancer awareness, etc., the possibilities are endless.

It is yet another aspect of the present invention to provide a stamp that be capable of being selectively colored. More specifically, in one embodiment of the present invention the affixed stamp is selectively colored with Crayons®, colored pencils, paints, markers, or chalk, thereby increasing the artistic representation of the image. Alternatively, the stamp may be left un-colored if the user so desires. Preferably, the ink and colors used to alter a personal check will not substantially affect the personal check, and thus call in question its validity, by running or bleeding for example.

It is another aspect of the present invention to provide one or more stickers or decals that employ an image or images, which may be adapted to be selectively interconnected to the check in a predetermined location. Although the forgoing has dealt predominately with the use of stamps to selectively alter a check, one skilled in the art will appreciate that similar results may be achieved by the use of adhesive-backed stickers or decals. One skilled in the art will also appreciate that the non-exhaustive list of images or logos mentioned above will apply to this embodiment. More specifically, any image that may be used in the above-mentioned embodiments may be printed on a stamp that is adapted to affix onto paper. Further, stamps or decals of this embodiment of the present invention may use more detailed art work and may be selectively colored. In addition, glossy or clear-coat finishes may be used to enhance depictions on stickers or decals. Alternatively, reflection-enhancing means, such as glitter or holograms may be employed with any image to add further artistic qualities to the finished product.

Thus, it is one aspect of the present invention to provide a method of customizing a personal check with a stamp which comprises:
selecting a stamp that is adapted to imprint an image that conveys a specific mood or occasion;
applying ink to said stamp; and
applying said inked stamp to a personal check in a predetermined location, thereby creating an image on said personal check.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

FIG. 1 is a front plan view of a personal check employed in one embodiment of the present invention;

FIG. 2 is a front plan view of the embodiment of the invention shown in FIG. 1, wherein a stamp has been selectively affixed thereto;

FIG. 3A is a front plan view of the embodiment of the invention shown in FIG. 1, wherein a stamp of a boy has been selectively affixed and selectively colored;

FIG. 3B is a front plan view of the embodiment of the invention shown in FIG. 1, wherein a stamp of a bride has been selectively affixed and selectively colored;

FIG. 3C is a front plan view of the embodiment of the invention shown in FIG. 1, wherein a stamp of a Christmas tree has been selectively affixed and selectively colored;

FIG. 3D is a front plan view of the embodiment of the invention shown in FIG. 1, wherein a stamp of a ghost has been selectively affixed and selectively colored; and

FIG. 4 are front plan views of additional examples of stamp depictions that may be employed with the embodiment of the present invention shown in FIG. 1.

### DETAILED DESCRIPTION

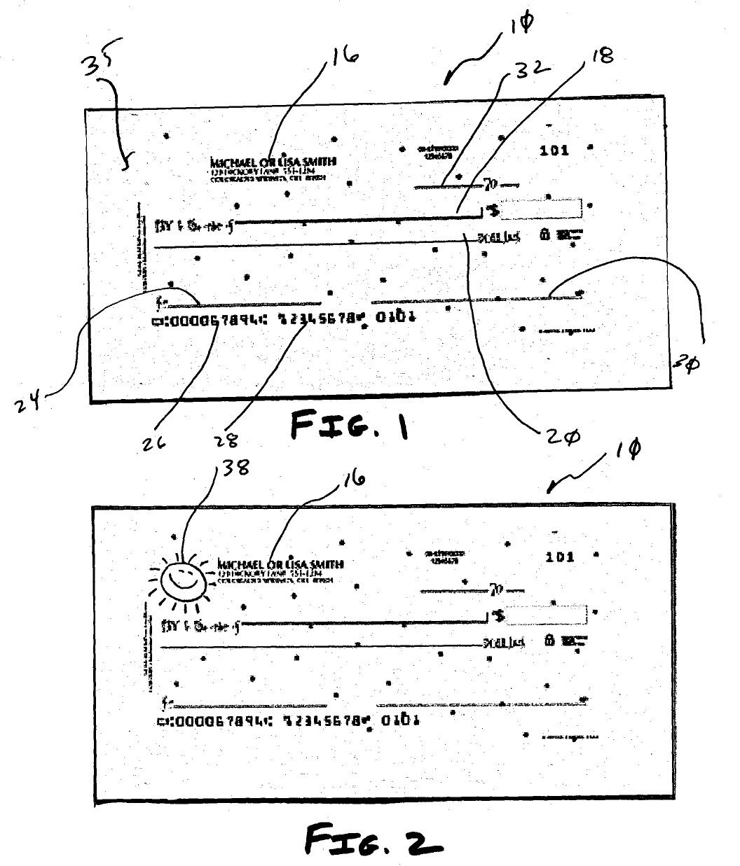

Referring now to FIGS. 1-4, one embodiment of the present invention is shown herein. More specifically, the present invention includes a check 10 which further includes at least an address line 16, a transferee line 18, amount of transfer line 20, a memo line 24, an account number 26, a routing number 28, a signature line 30, and a date line 32. Preferably one embodiment of the present invention also includes a substantially blank area 35. This area is generally located adjacent to the address line 16 and is adapted to accept an image 38.

Referring now to FIG. 1, one embodiment of the present invention is shown herein which includes a blank area 35 adapted to receive an image. This embodiment of the present invention includes all the traditional information embodied on a personal check which is designed to be drawn on an account. In addition, an area adjacent to the address line 16 is left blank, which is adapted to receive an artistic image. The artistic image is generally used to signify an occasion, such as an anniversary, a birthday or a graduation, or alternatively to signify a holiday such as Christmas, Hanukkah, Halloween, Independence Day, etc. In addition, a feeling or a cause may also be depicted in the artistic image.

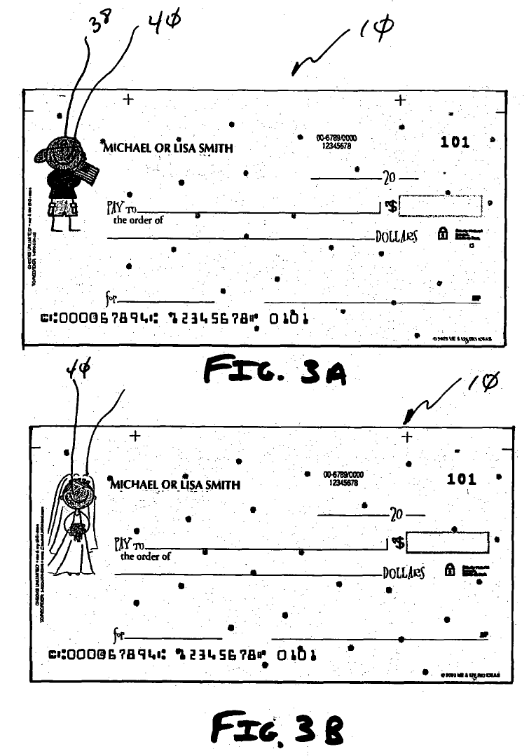

Referring now to FIG. 2, a stamp 38 affixed to one embodiment of the present invention is shown herein. More specifically, a smiley face sun is shown attached or affixed to the personal check 10 substantially on the blank area of the check. Alternatively, in another embodiment of the present invention, a sticker or decal 38 is affixed to the check 10. It should be appreciated by one skilled in the art that the image may be placed anywhere on the check as long as the document maintains its legal tender status, wherein no required information is disturbed.

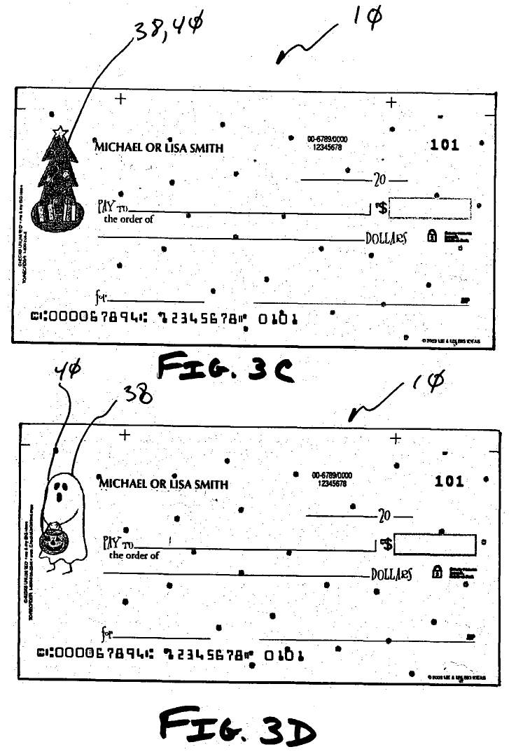

Referring now to FIG. 3, a stamp 38 that has been selectively colored 40 of the present invention is shown herein. In addition, the general method of affixing an artistic image 38 to a personal check 10 is described and shown hereinbelow. Initially, the user chooses the stamp 38 design to signify a certain event or mood, such as a cake when sending a gift of money to a loved one on their birthday. The stamp 38 is then placed in ink and subsequently selectively affixed to the space provided on the check 10. After a brief time for drying, the stamp 38 may be colored in as shown to add more artistic quality to the depiction. In one embodiment of the present invention, the ink and colors used in conjunction with the stamp are made of non-bleeding materials so that the check 10 is still accepted by merchants and financial institutions.

Alternatively, a sticker or decal 38 may be used as a canvas for the image to be selectively interconnected to the check 10. Initially, the user chooses the sticker or decal 38 design to signify a certain feeling or cause, such as a smiley face to denote happiness. The sticker 38 is generally removed from a backing material and then selectively affixed to the space provided on the check 10.

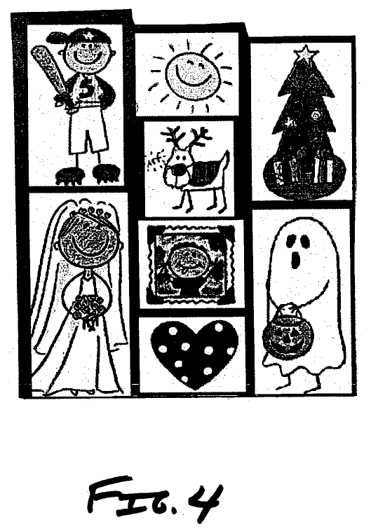

Referring now to FIG. 4, many examples of different colored stamps, stickers, or decals are shown herein. Although shown and described thus far have been a few examples of stamps, stickers, or decals that may be used in conjunction with the present invention, one skilled in the art will appreciate that the possibilities of different depictions are virtually unlimited such that any feeling, emotion, holiday, cause, event or otherwise maybe displayed to achieve the vision of the present invention.

To assist in the understanding of the present invention the following list of components and associated numbering found in the drawings is provided herein:

| # | Component |
|---|---|
| 10 | Personal Check |
| 16 | Address |
| 18 | Transferee Line |
| 20 | Amount of Transfer Line |
| 24 | Memo Line |
| 26 | Account Number |
| 28 | Routing Number |
| 30 | Signature Line |
| 32 | Date Line |
| 35 | Blank Area |
| 38 | Image selectively affixed by a stamp, sticker, or decal |
| 40 | Colored Portion of the Stamp |

While various embodiments of the present invention have been described in detail, it is apparent that modifications and adaptations of those embodiments will occur to those skilled in the art. However, it is to be expressly understood that such modifications adaptations are within the scope and spirit of the present invention, as set forth in the following claims.

1. A method of customizing personal checks comprising the steps of:
selecting a stamp that is adapted to imprint an image that conveys a specific feeling, event, occasion, cause, holiday, or logo;
applying ink to said stamp; and
selectively applying said inked stamp to a personal check in a predetermined location, thereby creating an image on said personal check.

2. The method of claim 1 further comprising the step of selectively coloring said image imprinted by said stamp.

3. The method of claim 1, wherein said personal check includes a substantially blank portion that is adapted to receive said image.

4. The method of claim 1, wherein said stamp is constructed predominately of rubber.

5. The method of claim 1, wherein said ink is substantially fixed after said application to said personal check, such that the occurrence of said ink bleeding or running is reduced.

6. The method of claim 1, wherein said image employed on said stamp indicates an event, such as a wedding, a graduation, or a birthday.

7. The method of claim 1, wherein said ink is red, blue, green, or a combination thereof.

8. The method of claim 2, wherein said coloring is performed with colored pencils, markers, or paints.

9. The method of claim 1, wherein said image contains text.

10. A customized personal check comprising;
a generally rectangular piece of paper that is recognized as legal tender, which includes a substantially undisturbed area thereon that is adapted to receive an image; and
an image selectively affixed to said substantially undisturbed area of said paper.

11. The customized personal check of claim 10, wherein said image is generated from an application device that has been in contact with ink.

12. The customized personal check of claim 10, wherein a sticker or decal is selectively affixed to said generally rectangular piece of paper, and wherein said sticker or decal contains said image.

13. The customized personal check of claim 10, wherein said image is affixed to said generally rectangular piece of paper by a user thereof.

14. The customized check of claim 10, wherein said substantially undisturbed area is located adjacent to an address listing of said generally rectangular piece of paper that is recognized as legal tender.

15. A method of supplying consumers with personal checks that are adapted to be selectively altered to express and idea, mood, cause, or event comprising the steps of:
obtaining a user's information;
affixing said information to a plurality of blank personal checks; and
sending said plurality of checks to said consumer with articles adapted to produce an image in a predetermined location on said personal checks.

16. The method of claim 15, wherein said information includes at least said user's name, address, account number, and routing number.

17. The method of claim 15, wherein said articles included at least one of the following: at least one predetermined stamp design, an ink pad, and at least one colored pencil.

18. The method of claim 15, wherein said articles included at least one predetermined sticker or decal design.

19. A system for selectively modifying personal checks comprising:
a personal check;
at least one of the following: an ink stamp, a sticker, or a decal, which is adapted to selectively transfer an image onto said personal check.

20. The system of claim 19, further comprising:
at least one coloring instrument for selectively altering said image, wherein said coloring instrument is a colored pencil, a colored marker, or a colored pen.

21. The system of claim 19, wherein said personal check includes a substantially blank area that is adapted to receive said image.

22. The system of claim 19, wherein said image depicts an event, a holiday, a feeling, an emotion, a cause, or a logo.

23. A method of customizing personal checks comprising the steps of:
selecting a sticker or decal, which employs an image that conveys a specific feeling, event, occasion, cause, holiday, or logo; and
selectively applying said sticker or decal to a personal check in a predetermined location, thereby creating an image on said personal check.

24. The method of claim 23, wherein said personal check includes a substantially blank portion that is adapted to receive said sticker or decal.

25. The method of claim 23, wherein said sticker or decal contains at least one of the following: glitter, a glossy finish, or a hologram.

26. The method of claim 23, wherein said image employed on said sticker or decal indicates an event, such as a wedding, a graduation, or a birthday.

27. The method of claim 23, wherein said image contains text.
